(19) United States
(12) Patent Application Publication
(10) Pub. No.: US 2026/0349305 A1
(43) Pub. Date: Nov. 5, 2026

(54) ELECTRONIC DEVICE

(71) Applicant: InnoLux Corporation, Miao-Li County (TW)

(72) Inventors: Ming-Chi GUO, Miao-Li County (TW); Hsing-Yuan HSU, Miao-Li County (TW); Po-Yang CHEN, Miao-Li County (TW); I-An YAO, Miao-Li County (TW)

(21) Appl. No.: 19/632,690

(22) Filed: Mar. 30, 2026

(30) Foreign Application Priority Data
Apr. 30, 2025 (CN) 202510564311.9

(51) Int. Cl. G02F 1/137; G02F 1/1347

(52) U.S. Cl. CPC G02F 1/13718; G02F 1/1347

(57) ABSTRACT

An electronic device includes: a reflective display including a first cholesterol liquid crystal layer; and a display disposed under the reflective display, wherein when the reflective display is in a mode including at least one image display area and at least one transparent area, a transmittance of the first cholesterol liquid crystal layer in the at least one transparent area is between 60% and 99% in a visible light band of 450 nm to 700 nm.

### CROSS-REFERENCE TO RELATED APPLICATIONS

This application claims the benefits of the Chinese Patent Application Serial Number 202510564311.9, filed on Apr. 30, 2025, the subject matter of which is incorporated herein by reference.

### BACKGROUND

### Field

The present disclosure relates to an electronic device. More specifically, the present disclosure relates to an electronic device comprising a reflective display and a display.

### Description of Related Art

With the continuous advancement of technology and in order to meet various needs, manufacturers continue to improve and research display devices. The application of display devices is no longer limited to screens, mobile phones, laptops and televisions. For example, tiled electronic devices can be developed to extend the application of display devices to video walls, billboards and other electronic devices used to display large images.

However, when an electronic device needs to display fixed images and videos or animations at the same time, it is generally necessary to manually change the layout position, resulting in low flexibility of the screen layout, which is not conducive to practical applications. Alternatively, the fixed image area will be constantly scanned and updated as the video or animation is displayed, resulting in high display power consumption.

Therefore, it is desirable to provide an electronic device to improve the conventional defects.

### SUMMARY

The present disclosure provides an electronic device, comprising: a reflective display comprising a first cholesterol liquid crystal layer; and a display disposed under the reflective display, wherein when the reflective display is in a mode comprising at least one image display area and at least one transparent area, a transmittance of the first cholesterol liquid crystal layer in the at least one transparent area is between 60% and 99% in a visible light band of 450 nm to 700 nm.

Other novel features of the disclosure will become more apparent from the following detailed description when taken in conjunction with the accompanying drawings.

### BRIEF DESCRIPTION OF DRAWINGS

FIG. 1 is a cross sectional schematic view of an electronic device according to one embodiment of the present disclosure.

FIG. 2 is an operation schematic view of an electronic device according to one embodiment of the present disclosure.

FIG. 3A is a top schematic view of an electronic device according to one embodiment of the present disclosure.

FIG. 3B is a top schematic view of an electronic device according to one embodiment of the present disclosure.

FIG. 4A is a schematic view of a reflective display according to one embodiment of the present disclosure.

FIG. 4B is a schematic view of a reflective display according to one embodiment of the present disclosure.

FIG. 5A is a cross sectional schematic view of an electronic device according to one embodiment of the present disclosure.

FIG. 5B is a cross sectional schematic view of an electronic device according to one embodiment of the present disclosure.

FIG. 6A is a pixel schematic view of a reflective display according to one embodiment of the present disclosure.

FIG. 6B is a pixel schematic view of a display according to one embodiment of the present disclosure.

### DETAILED DESCRIPTION

The following is a detailed description of the electronic device according to the embodiment of the present disclosure. It should be understood that the following description provides many different embodiments for implementing different aspects of some embodiments of the present disclosure. Specific examples of each component and its configuration are described below to simplify the embodiments of the present disclosure. Of course, these are only examples and are not intended to limit the present disclosure. In addition, similar and/or corresponding reference numerals may be used to identify similar and/or corresponding elements in different embodiments to clearly describe the present disclosure. However, the use of these similar and/or corresponding reference numerals is only for the purpose of simply and clearly describing some embodiments of the present disclosure, and does not imply any correlation between the different embodiments and/or structures discussed.

The embodiments of the present disclosure may be understood in conjunction with the drawings, which are also considered part of the disclosure. It should be understood that the drawings of the present disclosure are not drawn to scale, and in fact, the size of the elements may be arbitrarily enlarged or reduced in order to clearly show the features of the present disclosure. In addition, the directional terms mentioned in the present disclosure, such as “up”, “down”, “front”, “back”, “left”, “right”, etc., are only referenced to the directions of the accompanying drawings. Therefore, the directional terms used are for illustration and are not intended to limit the present disclosure. In the accompanying drawings, each diagram depicts the general characteristics of the methods, structures and/or materials used in a particular embodiment. However, these diagrams should not be interpreted as defining or limiting the scope or nature covered by these embodiments. For example, for the sake of clarity, the relative size, thickness and position of each layer, region and/or structure may be reduced or enlarged.

One structure (or layer, component, or substrate) described in the present disclosure is located on/above another structure (or layer, component, or substrate). This may mean that the two structures are adjacent and directly connected, or the two structures are adjacent rather than directly connected. Indirect connection means that there is at least one intermediary structure (or intermediary layer, intermediary component, intermediary substrate, or intermediary spacer) between two structures. The lower surface of one structure is adjacent to or directly connected to the upper surface of the intermediary structure, and the upper surface of another structure is adjacent to or directly connected to the lower surface of the intermediary structure. The intermediary structure can be composed of a single-layer or multi-layer solid structure or a non-solid structure, and there is no limit. In the present disclosure, when a structure is disposed “on” another structure, it may mean that the structure is “directly” on the other structure, or that the structure is “indirectly” on the other structure, that is, at least one structure is also sandwiched between the structure and the other structure. In the present disclosure, the term “relatively disposed” or “disposed relative to” refers to, for example, the elements substantially overlapping each other, but the present disclosure is not limited thereto.

In addition, it should be understood that the ordinal numbers used in the description and the claims, such as “first”, “second”, etc., are intended only to describe the elements claimed and imply or represent neither that the (these) elements have any proceeding ordinals, nor that sequence between one claimed element and another claimed element or between steps of a manufacturing method. The use of these ordinals is merely to differentiate one claimed element having a certain designation from another claimed element having the same designation. The same words may not be used in the claim and the description. For example, the first element in the description may be the second element in the claim.

In some embodiments of the present disclosure, terms related to joining and connecting, such as “connection”, “interconnection”, etc., unless otherwise defined, may mean that two structures are in direct contact, or may also mean that two structures are not in direct contact where other structures are located between these two structures. The terms “joint” and “connection” can also include situations where both structures are movable, or where both structures are fixed. In addition, the term “electrically connected” or “coupled” includes any direct and indirect electrical connection means.

In the present specification, the terms, such as “about”, “substantially”, or “approximately”, are generally interpreted as within 10%, 5%, 3%, 2%, 1%, or 0.5% of a given value or range. Unless otherwise stated, when a value is “in a range from a first value to a second value” or “in a range between a first value and a second value”, the value can be the first value, the second value, or another value between the first value and the second value. In addition, any two values or directions used for comparison may have certain errors. If the first value is equal to the second value, it implies that there may be an error of about 10% between the first value and the second value. If the first direction is perpendicular to the second direction, the angle between the first direction and the second direction may be between 80° and 100°. If the first direction is parallel to the second direction, the angle between the first direction and the second direction may be between 0° and 10°. In the present disclosure, the term “the given range is from the first value to the second value” and “the given range falls within the range of the first value to the second value” mean that the given range includes the first value, the second value and another value between the first value and the second value.

Furthermore, according to some embodiments of the present disclosure, the thickness, the length, the width, or the distance and angle between elements may be measured by using an optical microscope (OM), scanning electron microscope (SEM), film thickness profiler (α-step), ellipsometer, or other suitable methods. More specifically, according to some embodiments, a scanning electron microscope can be used to obtain a cross-sectional image of the structure and measure the thickness, length, width of each element or the distance and angle between elements.

In the specification and the appended claims of the present disclosure, certain words are used to refer to specific elements. Those skilled in the art should understand that electronic device manufacturers may refer to the same components by different names. The present specification does not intend to distinguish between elements that have the same function but have different names. In the following description and claims, words such as “comprising”, “including”, “containing”, and “having” are open-ended words, so they should be interpreted as meaning “containing but not limited to . . . ”. Therefore, when the terms “comprising”, “including”, “containing” and/or “having” are used in the description of the present disclosure, they specify the existence of corresponding features, regions, steps, operations and/or components, but do not exclude the existence of one or more corresponding features, regions, steps, operations and/or components.

It should be noted that the following embodiments may be implemented by replacing, reorganizing, or mixing features of several different embodiments without departing from the spirit of the present disclosure to implement other embodiments. The features of the various embodiments may be mixed and matched as desired as long as they do not violate the spirit of the invention or conflict with each other.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those known in the art, the background of the present disclosure or the context of the present specification, and should not be read by an ideal or over-formal way.

The electronic device of the present disclosure may include electronic components, and the electronic components can include passive components, active components or a combination thereof, such as capacitors, resistors, inductors, varactor diodes, variable capacitors, filters, diodes, transistors, sensors, microelectromechanical system components (MEMS), liquid crystal chips, etc., but the present disclosure is not limited thereto. The diode may include light emitting diode or non-light emitting diode. The diode includes a P-N junction diode, a PIN diode or a constant current diode. The light emitting diode may include, for example, an organic light emitting diode (OLED), a mini LED, a micro LED, a quantum dot LED, fluorescence, phosphors, other suitable material or a combination thereof, but the present disclosure is not limited thereto. The sensor may include, for example, a capacitive sensor, an optical sensor, an electromagnetic sensor, a fingerprint sensor (FPS), a touch sensor, an antenna or a pen sensor, but the present disclosure is not limited thereto. The following will be a display device as an electronic device to illustrate the present disclosure, but the present disclosure is not limited thereto.

It should be noted that the following embodiments may be implemented by replacing, reorganizing, or mixing features of several different embodiments without departing from the spirit of the present disclosure to implement other embodiments. The features of the various embodiments may be mixed and matched as desired as long as they do not violate the spirit of the invention or conflict with each other. It should be noted that the technical solutions provided in the following different embodiments can be replaced, combined or mixed with each other to form another embodiment without violating the spirit of the present disclosure.

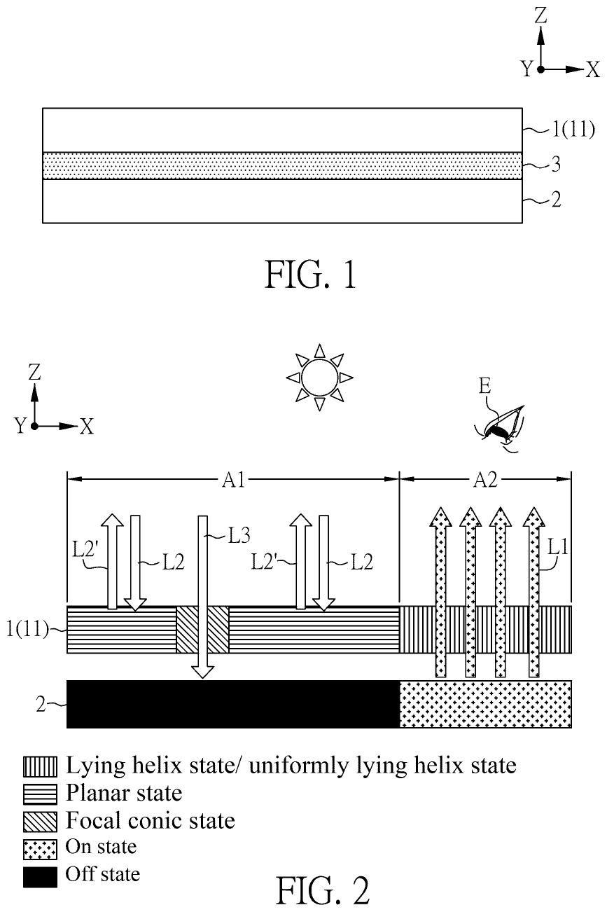

FIG. 1 is a cross sectional schematic view of an electronic device according to one embodiment of the present disclosure. FIG. 2 is an operation schematic view of an electronic device according to one embodiment of the present disclosure.

In one embodiment of the present disclosure, as shown in FIG. 1 and FIG. 2, the electronic device may comprise: a reflective display 1 comprising a first cholesterol liquid crystal layer 11; and a display 2 disposed under the reflective display 1; wherein when the reflective display 1 is in a mode comprising at least one image display area A1 and at least one transparent area A2, a transmittance of the first cholesterol liquid crystal layer 11 in the at least one transparent area A2 is between 60% and 99% in a visible light band of 450 nm to 700 nm. By combining the reflective display 1 and the display 2, the electronic device of the present disclosure can display static images provided by the reflective display 1 in the image display area A1, and display dynamic images or static images provided by the display 2 in the transparent area A2. More specifically, as shown in FIG. 2, the first cholesterol liquid crystal layer 11 in the transparent area A2 may switch to a lying helix state or a uniformly lying helix state, so dynamic images or static images displayed by the display 2 in the transparent area A2 can be observed by human eyes E. The first cholesterol liquid crystal layer 11 in the image display area A1 may switch to a planer state or a focal conic state, so static images displayed by the reflective display 1 in the image display area A1 may be observed by human eyes E. Since cholesterol liquid crystals are stable in the lying helix state, the uniformly lying helix state, the planer state and the focal conic state, displaying static images through reflective display 1 can reduce the display power consumption of electronic devices and achieve power saving effect. In the present disclosure, the reflective display 1 may have several modes. For example, when the entire first cholesterol liquid crystal layer 11 switches into the planer state or the focal conic state, the entire reflective display 1 is present in a mode of an image display area A1. When a part of the first cholesterol liquid crystal layer 11 switches to the planer state or the focal conic state and a part of the first cholesterol liquid crystal layer 11 is switch to the lying helix state or the uniformly lying helix state, as shown in FIG. 2, the reflective display 1 is in a mode comprising at least one image display area A1 and at least one transparent area A2. When the entire first cholesterol liquid crystal layer 11 switches into the lying helix state or the uniformly lying helix state, the entire reflective display 1 is present in a mode of a transparent area A2.

When the first cholesterol liquid crystal layer 11 in the transparent area A2 switches to the lying helix state or the uniformly lying helix state, the transmittance of the first cholesterol liquid crystal layer 11 in the visible light band of 450 nm to 700 nm is between 60% and 99%, for example, between 75% and 99% or between 70% and 99%, but the present disclosure is not limited thereto. Thus, most of the light L1 emitting from the display 2 under the reflective display 1 may pass through the first cholesterol liquid crystal layer 11 in the transparent area A2, and human eyes E may observe dynamic images or static images displayed by the display 2. When the first cholesterol liquid crystal layer 11 in the image display area A1 switches to the planer state, the first cholesterol liquid crystal layer 11 in the image display area A1 may reflect colored light with specific wavelengths (that is, the transmittance of the first cholesterol liquid crystal layer 11 to light with specific wavelengths is less than 55%, but the transmittance thereof to light in other visible light bands is greater than 55%, for example, may be between 60% and 99% or between 70% and 99%). Thus, at least part of the incident light L2 may be reflected by the first cholesterol liquid crystal layer 11 (that is, the incident light L2 is reflected into reflected light L2′), thereby the human eyes E may observe static images displayed by the reflective display 1. When the first cholesterol liquid crystal layer 11 in the image display area A1 switches to the focal conic state, the transmittance of the first cholesterol liquid crystal layer 11 in a visible light band of 450 nm to 700 nm may be greater than 0% and less than 60%. Thus, at least part of the incident light L3 may pass through the first cholesterol liquid crystal layer 11 to the display 2. At this time, if the display 2 under the reflective display 1 displays black images (for example, switching into an off state), the human eyes E may observe black images.

In one embodiment of the present disclosure, when the first cholesterol liquid crystal layer 11 in the transparent area A2 switches to the lying helix state or the uniformly lying helix state and the display 2 overlapped with the transparent area A2 in the normal direction Z of the electronic device switches to the dynamic image or the static image (for example, switching to the on state), most of the light L1 may pass through the first cholesterol liquid crystal layer 11. Thus, the electronic device may display dynamic images or static images provided by the display 2 in the transparent area A2. When the first cholesterol liquid crystal layer 11 in the image display area A1 switches to the planer state and/or the focal conic state and the display 2 overlapped with the image display area A1 in the normal direction Z of the electronic device display black images, most of the light L2 may be reflected by the first cholesterol liquid crystal layer 11 and a part of the incident L3 may pass through the first cholesterol liquid crystal layer 11 to the display 2 displaying black images. Thus, the electronic device may display static images in the image display area A1. By designing the display 2, which overlaps with the image display area A1, to display black images and using the reflective display 1 to display static images, the overall display power consumption of the electronic device can be reduced, achieving a power-saving effect.

In the present disclosure, the first cholesterol liquid crystal layer 11, for example, may comprise cholesterol liquid crystals that reflect blue light in the planer state, cholesterol liquid crystals that reflect green light in the planer state, and/or cholesterol liquid crystals that reflect red light in the planer state, but the present disclosure is not limited thereto. The design can be customized to enable monochrome and/or color display for the reflective display 1.

In the present disclosure, the reflective display 1 may further comprise an electrode layer (not shown in the figure). Voltages may be applied to the electrode layer to generate an electric field to control the states of the first cholesterol liquid crystal layer 11 (for example, the lying helix state, the uniformly lying helix state, the planer state or the focal conic state). For example, 35 V to 45 V may be applied to the electrode layer to switch the first cholesterol liquid crystal layer 11 to the planer state, 25 V to 35 V may be applied to the electrode layer to switch the first cholesterol liquid crystal layer 11 to the focal conic state, and 0 V to 25 V may be applied to the electrode layer to switch the first cholesterol liquid crystal layer 11 to the lying helix state or the uniformly lying helix state, but the present disclosure is not limited thereto.

In one embodiment of the present disclosure, 20 V is applied to the entire electrode layer to switch the entire first cholesterol liquid crystal layer 11 to the lying helix state or the uniformly lying helix state. Next, for example, 40 V is applied to the portion of the electrode layer corresponding to the image display area A1, and the voltage is removed after 1 ms to 5 ms to switch the portion of the first cholesterol liquid crystal layer 11 at the image display area A1 to the planer state; for example, 30 V is applied to the portion of the electrode layer corresponding to the image display area A1, and the voltage is removed after 1 ms to 5 ms to switch the portion of the first cholesterol liquid crystal layer 11 in the image display area A1 to the focal conic state; and, for example, 0 V to 25 V is applied to the portion of the electrode layer corresponding to the transparent area A2, and the voltage is removed after 1 ms to 5 ms to switch the first cholesterol liquid crystal layer 11 in the transparent area A2 to the lying helix state or the uniformly lying helix state.

In the present disclosure, the display 2 is not particularly limited, and may comprise, for example, an organic light emitting diode display, an inorganic light emitting diode display or a liquid crystal display, but the present disclosure is not limited thereto. Each display 2 may comprise any required components, which are not described again here. In one embodiment of the present disclosure, as shown in FIG. 1, the size of the reflective display 1 may be approximately equal to the size of the display 2. That is, in the normal direction Z of the electronic device, the projection area of the reflective display 1 may be approximately equal to the projection area of the display 2, but the present disclosure is not limited thereto. In other embodiments of the present disclosure, the sizes of the reflective display 1 and the display 2 may be respectively adjusted according to the needs.

In one embodiment of the present disclosure, as shown in FIG. 1, the electronic device may further comprise a transparent adhesive layer 3 disposed between the reflective display 1 and the display 2. The transparent adhesive layer 3 may be used to fix the reflective display 1 and the display 2 to each other. In the present disclosure, the material of the transparent adhesive layer 3 may comprise glass glue, optical glue, silicone, tape, hot melt adhesive, AB glue, two-component adhesive, polymer adhesive, other suitable adhesive materials, or a combination thereof, but the present disclosure is not limited thereto.

In one embodiment of the present disclosure, even not shown in the figure, the electronic device may further comprise a brightness sensing element disposed adjacent to the reflective display 1. More specifically, the brightness sensing element may be disposed on a side of the reflective display 1 away from the display 2. In the present disclosure, the brightness sensing element may be, for example, an ambient brightness sensing element, a reflective display brightness sensing element or a combination thereof. The ambient brightness sensing element may be used to detect the brightness of the ambient light, and the reflective display brightness sensing element may be used to detect the brightness of the reflective display 1. Thus, the display 2, which overlaps with the transparent area A2 in the normal direction of the electronic device, can adjust its brightness according to the brightness sensing element, thereby improving the display quality of the electronic device.

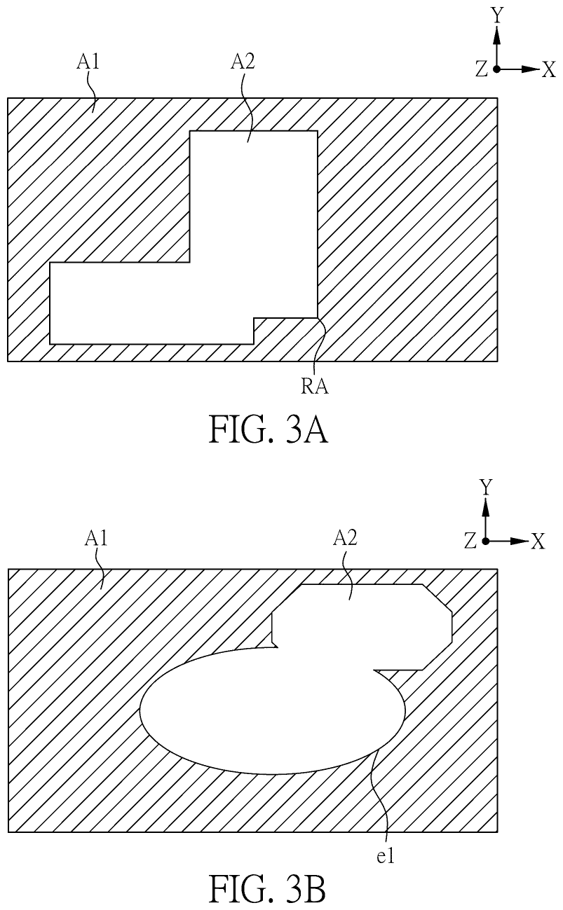

FIG. 3A is a top schematic view of an electronic device according to one embodiment of the present disclosure. FIG. 3B is a top schematic view of an electronic device according to one embodiment of the present disclosure. For ease of explanation, some components are omitted in FIG. 3A and FIG. 3B. In FIG. 3A and FIG. 3B, the image display area A1 of the reflective display 1 is represented by a filled pattern, and the transparent area A2 of the reflective display 1 is represented by a white pattern.

In the present disclosure, the size and position of the image display area A1 and transparent area A2 of the reflective display 1 can be controlled by switching the state of the first cholesterol liquid crystal layer 11. In other words, the positions of the image display area A1 and the transparent area A2 of the reflective display 1 are not fixed. For example, when the first cholesterol liquid crystal layer 11 in a region is switched to the lying helix state or the uniformly lying helix state, this region can be defined as the transparent area A2 of the reflective display 1; and when the first cholesterol liquid crystal layer 11 in another region is switched to the planer state or the focal conic state, this another region can be defined as the image display area A1 of the reflective display 1, but the present disclosure is not limited thereto. Thus, in the electronic device of the present disclosure, various screen layouts can be achieved by controlling the image display area A1 and the transparent area A2 of the reflective display 1.

In the present disclosure, one image display area A1 and one transparent area A2 are used as an example in FIG. 3A and FIG. 3B, but the present disclosure is not limited thereto. In other embodiments, the numbers of the image display areas A1 and the transparent areas A2 may be adjusted according to the needs, for example, each can be 2, 3 or other suitable quantities. In the present disclosure, the shapes of the image display area A1 and the transparent area A2 are not particularly limited. The transparent areas A2 may have regular and/or irregular shapes. Suitable shapes may include, for example, circles, ovals, rectangles, rhombuses, triangles, trapezoids, or other suitable shapes. In one embodiment of the present disclosure, as shown in FIG. 3A, when viewed from the normal direction Z of the electronic device, the transparent area A2 may have a right angle RA. In one embodiment of the present disclosure, as shown in FIG. 3B, when viewed from the normal direction Z of the electronic device, the transparent area A2 may have an arc-shaped edge e1.

In the present disclosure, other detailed features of the electronic devices in FIG. 3A and FIG. 3B are similar to those shown in FIG. 1 and FIG. 2, and will not be repeated here.

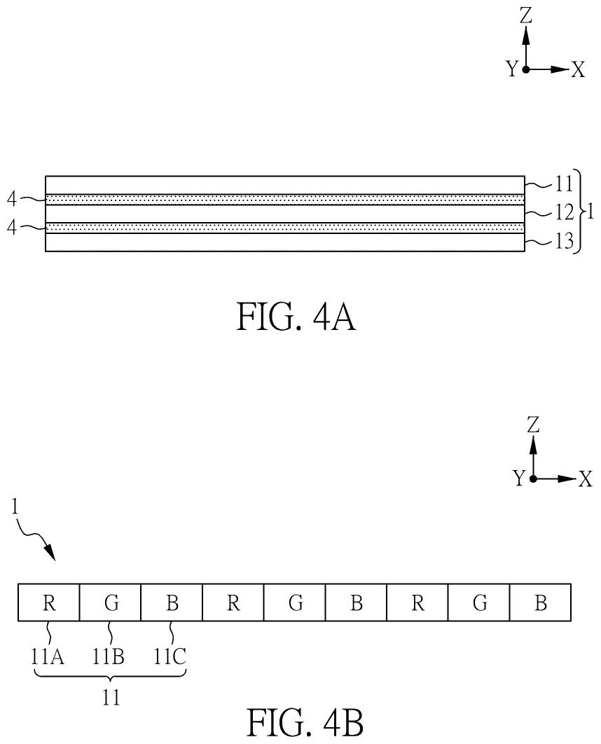

FIG. 4A is a schematic view of a reflective display according to one embodiment of the present disclosure.

In one embodiment of the present disclosure, the reflective display 1 of the electronic device shown in FIG. 1 may be, for example, as that shown in FIG. 4A. That is, the reflective display 1 may further comprise a second cholesterol liquid crystal layer 12 and a third cholesterol liquid crystal layer 13, the second cholesterol liquid crystal layer 12 is disposed under the first cholesterol liquid crystal layer 11, and the third cholesterol liquid crystal layer 13 is disposed under the second cholesterol liquid crystal layer 12. The second cholesterol liquid crystal layer 12 and the first cholesterol liquid crystal layer 11 reflect different colors of light in the planer state, and the third cholesterol liquid crystal layer 13, the first cholesterol liquid crystal layer 11 and the second cholesterol liquid crystal layer 12 reflect different colors of light in the planer state. For example, the first cholesterol liquid crystal layer 11 comprises cholesterol liquid crystals that reflect blue light in the planer state, the second cholesterol liquid crystal layer 12 comprises cholesterol liquid crystals that reflect green light in the planer state, and the third cholesterol liquid crystal layer 13 comprises cholesterol liquid crystals that reflect red light in the planer state, but the present disclosure is not limited thereto. When the first cholesterol liquid crystal layer 11, the second cholesterol liquid crystal layer 12 and the third cholesterol liquid crystal layer 13 meet the aforesaid design, the reflection efficiency of the incident light can be improved, thereby improving the display quality of the reflective display 1, or enabling the reflective display 1 to achieve color display.

In the present disclosure, as shown in FIG. 2 and FIG. 4A, in the transparent area A2 of the reflective display 1, the first cholesterol liquid crystal layer 11, the second cholesterol liquid crystal layer 12 and the third cholesterol liquid crystal layer 13 may be respectively switched to the lying helix state and/or the uniformly lying helix state. Thus, most of the light L1 emitting from the display 2 can pass through the transparent area A2 of the reflective display 1 (including the first cholesterol liquid crystal layer 11, the second cholesterol liquid crystal layer 12 and the third cholesterol liquid crystal layer 13) to display dynamic images or static images; in the image display area A1 of the reflective display 1, the first cholesterol liquid crystal layer 11, the second cholesterol liquid crystal layer 12 and the third cholesterol liquid crystal layer 13 may be respectively switched to the planer state and/or the focal conic state, so the reflective display 1 may display static images.

In one embodiment of the present disclosure, as shown in FIG. 4A, adhesive layers 4 may be selectively disposed between the first cholesterol liquid crystal layer 11, the second cholesterol liquid crystal layer 12 and the third cholesterol liquid crystal layer 13 of the reflective display 1 to fix the first cholesterol liquid crystal layer 11, the second cholesterol liquid crystal layer 12 and the third cholesterol liquid crystal layer 13 to each other. In the present disclosure, the material of the adhesive layer 4 may comprise glass glue, optical glue, silicone, tape, hot melt adhesive, AB glue, two-component adhesive, polymer adhesive, other suitable adhesive materials, or a combination thereof, but the present disclosure is not limited thereto.

In the present disclosure, the reflective display 1 can be actively driven or passively driven. When the reflective display 1 is actively driven, it can contain a plurality of transistors (not shown in the figure) to control the switching of each pixel in the reflective display 1.

FIG. 4B is a schematic view of a reflective display according to one embodiment of the present disclosure. In FIG. 4B, R represents the first cholesterol liquid crystal layer 11 reflecting red wavelength light in the planer state, G represents the first cholesterol liquid crystal layer 11 reflecting green wavelength light in the planer state, and B represents the first cholesterol liquid crystal layer 11 reflecting blue wavelength light in the planer state as an example.

In one embodiment of the present disclosure, the reflective display 1 of the electronic device shown in FIG. 1 may be as that shown in FIG. 4B. That is, the first cholesterol liquid crystal layer 11 may comprise a first region 11A, a second region 11B and a third region 11C, and the second region 11B is disposed between the first region 11A and the third region 11C. The first region 11A and the second region 11B of the first cholesterol liquid crystal layer 11 respectively reflect different colored light in the planer state, and the third region 11C, the first region 11A and the second region 11B of the first cholesterol liquid crystal layer 11 respectively reflect different colored light in the planer state, enabling the reflective display 1 to display in color.

The reflected wavelength of cholesteric liquid crystals is related to its refractive index and pitch, and the pitch is related to the thickness of the cholesteric liquid crystal layer. Therefore, light with different wavelength ranges can be reflected by adjusting the thicknesses of the first cholesterol liquid crystal layer 11 in the first region 11A, the second region 11B, and the third region 11C. For example, the cholesteric liquid crystals in first region 11A can reflect red wavelength light in the planer state, the cholesteric liquid crystals in the second region 11B can reflect green wavelength light in the planer state, and the cholesteric liquid crystals in third region 11C can reflect blue wavelength light in the planer state, but the present disclosure is not limited thereto.

In the present disclosure, as shown in FIG. 2 and FIG. 4B, the first cholesterol liquid crystal layer 11 in the first region 11A, the second region 11B and/or the third region 11C in the transparent area A2 of the reflective display 1 may respectively switch to the lying helix state and/or the uniformly lying helix state. Thus, most of the light L1 emitting from the display 2 may pass through the transparent area A2 of the reflective display 1 to display dynamic images or static images; the first cholesterol liquid crystal layer 11 in the first region 11A, the second region 11B and/or the third region 11C of the image display area A1 of the reflective display 1 may be respectively switched to the planer state and/or the focal conic state, and the electronic device may display the static images of the reflective display 1.

In the present disclosure, a cross-sectional view of the reflective display 1 is used as an example in FIG. 4B, and three first regions 11A, three second regions 11B and three third regions 11C are used as an example in FIG. 4B, but the present disclosure is not limited thereto; and the numbers and positions of the first regions 11A, the second regions 11B and the third regions 11C may be adjusted according to the needs and are not described again here. In the present disclosure, the reflective display 1 can be actively driven or passively driven. When the reflective display 1 is actively driven, it can contain a plurality of transistors (not shown in the figure) to control the switching of each pixel in the reflective display 1.

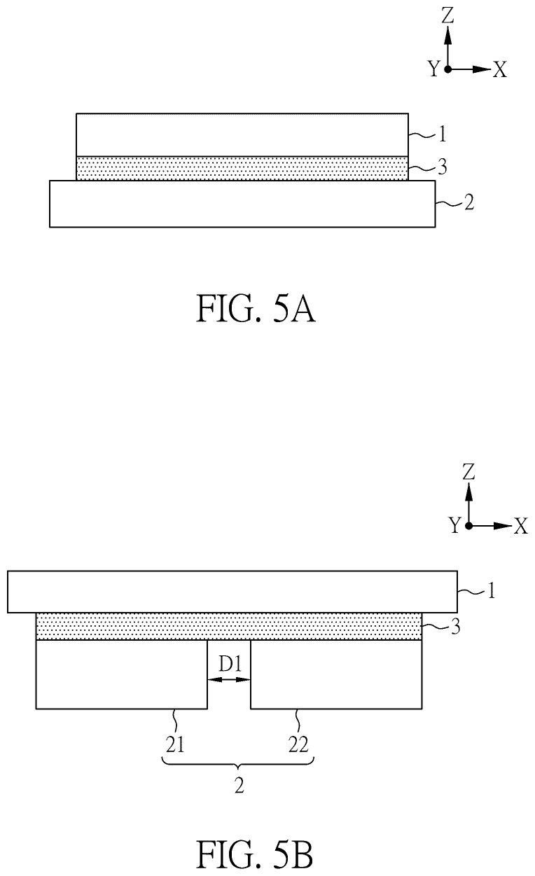

FIG. 5A is a cross sectional schematic view of an electronic device according to one embodiment of the present disclosure. The electronic device shown in FIG. 5A is similar to that shown in FIG. 1, except for the following differences.

In one embodiment of the present disclosure, as shown in FIG. 5A, the size of the reflective display 1 may be different from the size of the display 2. More specifically, for example, the size of the reflective display 1 may be less than the size of the display 2. In other words, in the normal direction Z of the electronic device, the projection area of the reflective display 1 may be less than the projection area of the display 2.

In the present disclosure, other detail features of the electronic device shown in FIG. 5A may be similar to those shown in FIG. 1 and FIG. 2, which are not described again here.

FIG. 5B is a cross sectional schematic view of an electronic device according to one embodiment of the present disclosure. The electronic device shown in FIG. 5B is similar to that shown in FIG. 1, except for the following differences.

In one embodiment of the present disclosure, as shown in FIG. 5B, the size of the reflective display 1 may be different from the size of the display 2. More specifically, for example, the size of the reflective display 1 may be greater than the size of the display 2. In other words, in the normal direction Z of the electronic device, the projection area of the reflective display 1 may be greater than the projection area of the display 2.

In one embodiment of the present disclosure, as shown in FIG. 5B, the display 2 may comprise a first portion 21 and a second portion 22 disposed adjacent to the first portion 21, and the first portion 21 and the second portion 22 are respectively fixed to the reflective display 1 through the transparent adhesive layer 3. In one embodiment of the present disclosure, as shown in FIG. 5B, the first portion 21 and the second portion 22 of the display 2 may be separated by a distance D1, and the size of the distance D1 is not particularly limited and may be adjusted according to the needs. In addition, in some embodiments, the distance D1 may be, for example, 0.

In the present disclosure, other detail features of the electronic device shown in FIG. 5B may be similar to those shown in FIG. 1 and FIG. 2, which are not described again here.

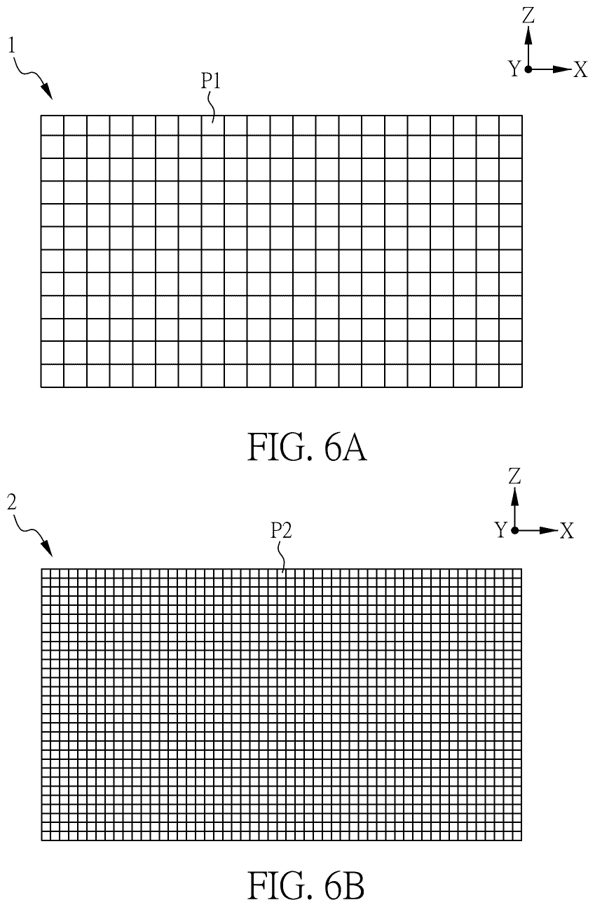

FIG. 6A is a pixel schematic view of a reflective display according to one embodiment of the present disclosure. FIG. 6B is a pixel schematic view of a display according to one embodiment of the present disclosure.

In one embodiment of the present disclosure, as shown in FIG. 6A and FIG. 6B, the resolution of the reflective display 1 may be different from the resolution of the display 2. For example, the resolution of the reflective display 1 may be less than the resolution of the display 2. More specifically, the reflective display 1 may comprise a plurality of pixels P1, and the display 2 may comprise a plurality of pixels P2, wherein the number of the pixels P1 in the reflective display 1 may be less than the number of the pixels P2 in the display 2, but the present disclosure is not limited thereto. In the present disclosure, the number of the pixels shown in FIG. 6A and FIG. 6B are used as an example, but the present disclosure is not limited thereto. The number of the pixels in the reflective display 1 and the display 2 may be adjusted according to the needs.

In other embodiments of the present disclosure, even not shown in the figure, the number of the pixels P1 in the reflective display 1 may be approximately equal to the number of the pixel P2 in the display 2; that is, the resolution of the reflective display 1 may be approximately equal to the resolution of the display 2. Alternatively, the number of the pixels P1 in the reflective display 1 may be greater than the number of the pixels P2 in the display 2; that is, the resolution of the reflective display 1 may be greater than the resolution of the display 2.

In the present disclosure, other detail features of the reflective display 1 shown in FIG. 6A may be similar to those shown in FIG. 1, FIG. 2, FIG. 4A and FIG. 4B, and other detail features of the display 2 shown in FIG. 6B may be similar to those shown in FIG. 1 and FIG. 2, which are not described again here.

The present disclosure combines the reflective display 1 and the display 2 to achieve various screen layouts for the image display area A1 and the transparent area A2 by switching the state of the cholesteric liquid crystal layer in the reflective display 1. Furthermore, by controlling the display 2, the overall display power consumption of electronic devices can be reduced, achieving energy-saving effects.

The specific embodiments described above should be interpreted as illustrative only and not as limiting the remainder of this disclosure in any way.

Although the present disclosure has been explained in relation to its embodiment, it is to be understood that many other possible modifications and variations can be made without departing from the spirit and scope of the disclosure as hereinafter claimed.

1. An electronic device, comprising:
a reflective display comprising a first cholesterol liquid crystal layer; and
a display disposed under the reflective display,
wherein when the reflective display is in a mode comprising at least one image display area and at least one transparent area, a transmittance of the first cholesterol liquid crystal layer in the at least one transparent area is between 60% and 99% in a visible light band of 450 nm to 700 nm.

2. The electronic device of claim 1, wherein the first cholesterol liquid crystal layer in the at least one transparent area switches to a lying helix state or an uniformly lying helix state.

3. The electronic device of claim 1, wherein the transmittance of the first cholesterol liquid crystal layer in the at least one transparent area is between 70% and 99% in the visible light band of 450 nm to 700 nm.

4. The electronic device of claim 1, wherein the transmittance of the first cholesterol liquid crystal layer in the at least one transparent area is between 75% and 99% in the visible light band of 450 nm to 700 nm.

5. The electronic device of claim 1, wherein the display overlapped with the at least one transparent area switches to a dynamic image or a static image in a normal direction of the electronic device.

6. The electronic device of claim 1, wherein the first cholesterol liquid crystal layer in the at least one image display area switches to a planer state or a focal conic state.

7. The electronic device of claim 1, wherein a transmittance of the first cholesterol liquid crystal layer to light with specific wavelengths is less than 55% when the first cholesterol liquid crystal layer in the at least one image display area switches to a planer state.

8. The electronic device of claim 1, wherein a transmittance of the first cholesterol liquid crystal layer in the visible light band of 450 nm to 700 nm is greater than 0% and less than 60% when the first cholesterol liquid crystal layer in the at least one image display area switches to a focal conic state.

9. The electronic device of claim 1, wherein the first cholesterol liquid crystal layer in the at least one image display area switches to a planer state and/or a focal conic state, and the display overlapped with the at least one image display area displays a black image in a normal direction of the electronic device.

10. The electronic device of claim 1, wherein the display comprises an organic light emitting diode display, an inorganic light emitting diode display or a liquid crystal display.

11. The electronic device of claim 1, wherein a resolution of the reflective display is different from a resolution of the display.

12. The electronic device of claim 11, wherein the resolution of the reflective display is less than the resolution of the display.

13. The electronic device of claim 1, wherein a size of the reflective display is different from a size of the display.

14. The electronic device of claim 1, wherein the reflective display further comprises a second cholesterol liquid crystal layer disposed under the first cholesterol liquid crystal layer, and the second cholesterol liquid crystal layer and the first cholesterol liquid crystal layer reflect different colors of light in a planer state.

15. The electronic device of claim 14, wherein the first cholesterol liquid crystal layer comprises cholesterol liquid crystals that reflect blue light in the planer state, and the second cholesterol liquid crystal layer comprises cholesterol liquid crystals that reflect green light in the planer state.

16. The electronic device of claim 14, wherein the reflective display further comprises a third cholesterol liquid crystal layer disposed under the second cholesterol liquid crystal layer, and the third cholesterol liquid crystal layer, the first cholesterol liquid crystal layer and the second cholesterol liquid crystal layer reflect different colors of light in a planer state.

17. The electronic device of claim 16, wherein the third cholesterol liquid crystal layer comprises cholesterol liquid crystals that reflect red light in the planer state.

18. The electronic device of claim 1, further comprising a transparent adhesive layer disposed between the reflective display and the display.

19. The electronic device of claim 1, further comprising a brightness sensing element disposed adjacent to the reflective display.

20. The electronic device of claim 1, wherein the display comprises a first portion and a second portion disposed adjacent to the first portion, and the first portion and the second portion are separated by a distance.
